(19) United States
(12) Patent Application Publication
(10) Pub. No.: US 2013/0209232 A1
(43) Pub. Date: Aug. 15, 2013

(54) MULTI-LOBED COOLING HOLES IN GAS TURBINE ENGINE COMPONENTS HAVING THERMAL BARRIER COATINGS

(71) Applicants: JinQuan Xu, Groton, CT (US); Edward F. Pietraszkiewicz, Southington, CT (US); Mark F. Zelesky, Bolton, CT (US); Glenn Levasseur, Colchester, CT (US); Dominic J. Mongillo, West Hartford, CT (US)

(72) Inventors: JinQuan Xu, Groton, CT (US); Edward F. Pietraszkiewicz, Southington, CT (US); Mark F. Zelesky, Bolton, CT (US); Glenn Levasseur, Colchester, CT (US); Dominic J. Mongillo, West Hartford, CT (US)

(21) Appl. No.: 13/543,932

(22) Filed: Jul. 9, 2012

Related U.S. Application Data
(60) Provisional application No. 61/599,366, filed on Feb. 15, 2012.
(60) Provisional application No. 61/599,372, filed on Feb. 15, 2012.
(60) Provisional application No. 61/599,379, filed on Feb. 15, 2012.
(60) Provisional application No. 61/599,381, filed on Feb. 15, 2012.
(60) Provisional application No. 61/599,386, filed on Feb. 15, 2012.

(51) Int. Cl. F01D 5/18; F01D 9/02; B05D 3/06; B05D 7/00; B05D 3/14

(52) U.S. Cl. 415/116; 427/299; 427/540; 427/555; 416/97 R

(57) ABSTRACT

A gas turbine engine component includes a wall with an inner face and an outer skin. A plurality of cooling air holes extend from the inner face to the outer skin. The cooling holes include an inlet merging into a metering section, and a diffusion section downstream of the metering section, and extend to an outlet at the outer skin. The diffusion section includes a plurality of lobes. A coating layer is formed on the outer skin, with at least a portion of the plurality of lobes formed within the thermal barrier coating. A method of forming such a component is also disclosed.

### CROSS-REFERENCE TO RELATED APPLICATIONS

This patent application claims priority to U.S. Provisional Patent Application Ser. No. 61/599,366 filed Feb. 15, 2012, entitled EDM Method For Multi-Lobed Cooling Hole; U.S. Provisional Patent Application Ser. No. 61/599,372 filed Feb. 15, 2012, entitled Multi-Lobed Cooling Hole And Method Of Manufacture; U.S. Provisional Patent Application Ser. No. 61/599,379 filed Feb. 15, 2012, entitled Multi-Lobed Cooling Hole And Method Of Manufacture; U.S. Provisional Patent Application Ser. No. 61/599,381 filed Feb. 15, 2012, entitled Tri-Lobed Cooling Hole And Method Of Manufacture; and U.S. Provisional Patent Application Ser. No. 61/599,386 filed Feb. 15, 2012, entitled Methods For Producing Multi-Lobed Cooling Holes, each of which is incorporated by reference herein, in its entirety.

### BACKGROUND OF THE INVENTION

This application relates to a component for use in a gas turbine engine that has multi-lobed cooling holes, and a thermal barrier coating, and to a method of making the same.

Gas turbine engines are known, and typically include a compressor section compressing air and delivering it into a combustion section. The air is mixed with fuel and ignited, and products of this combustion pass downstream over turbine rotors.

The products of combustion are extremely hot, and components in the combustion section, a turbine section and downstream of the turbine section, are subject to extremely high temperatures. Thus, air-cooling techniques are typically provided for many of these components.

One type of component would be a rotating blade, and static airfoils as are found in the turbine section. These components are provided with cooling air holes which take the air from an internal cavity and deliver it to an outer skin of the component.

One type of cooling air hole exits at the skin of the component, and allows the cooling air to move along the skin.

The cooling hole may begin with an inlet located at an inner wall surface, and the inlet extends to a metering section. The metering section merges into a diffusion section. The diffusion section may include a plurality of lobes.

A first lobe may diverge longitudinally and laterally from the metering section. The second lobe may also diverge longitudinally and laterally from the metering section. An upstream end is located at the outlet, and a trailing edge can be defined opposite the upstream end and located at the outlet, and between a first and second sidewall. The first sidewall has a first edge extending along the outlet between the upstream end and the trailing edge. The first edge diverges laterally from the upstream end and converges laterally before reaching the trailing edge. The second sidewall has a second edge extending along the outlet between the upstream end and the trailing edge, generally opposite the first sidewall. The second edge diverges laterally from the upstream end and converges laterally for reaching the trailing edge.

The so-called multi-lobed cooling holes provide valuable benefits in that they minimize vortexes in the cooling air, which allows the cooling air to remain along the skin for a greater period of time than has been the case with non-multi-lobed cooling holes. In addition, they cover a wider area. For any number of reasons, multi-lobed cooling holes are beneficial.

Gas turbine engine components are also provided with thermal barrier coatings to help them exist in the extremely hot temperatures in the area subject to the combustion, or products of combustion.

In the past, the prior art has formed multi-lobed cooling holes by utilizing electro-discharge machining (“EDM”). However, electro-discharge machining cannot be utilized on a thermal barrier coating.

### SUMMARY OF THE INVENTION

In one featured embodiment, a gas turbine engine component has a wall with an inner face, and a skin. A plurality of cooling holes extend from the inner face to the skin. The cooling holes include an inlet extending from the inner face and merging into a metering section, and a diffusion section downstream of the metering section, and extending to an outlet at the skin. The diffusion section includes a plurality of lobes, and a coating layer at the skin, with at least a portion of the plurality of lobes formed within the coating layer.

In another embodiment according to the previous embodiment, the plurality of lobes includes a first lobe that diverges longitudinally and laterally from the metering section, a second lobe that diverges longitudinally and laterally from the metering section, an upstream end located at the outlet, and a trailing edge defined opposite the upstream end and located at the outlet, and between a first and second sidewall. The first sidewall has a first edge extending along the outlet between the upstream end and the trailing edge. The first edge diverges laterally from the upstream end and converges laterally before reaching the trailing edge. The second sidewall has a second edge extending along the outlet between the upstream end and the trailing edge, and generally opposite the first sidewall. The second edge diverges laterally from the upstream end and converges laterally before reaching the trailing edge.

In another embodiment according to any of the previous embodiments, the coating layer comprises a thermal barrier coating.

In another embodiment according to any of the previous embodiments, the coating layer includes a bonding layer attached to the metallic substrate between the thermal barrier coating and the metallic substrate.

In another embodiment according to any of the previous embodiments, there is an intermediate coating layer between the thermal barrier coating and bonding layer.

In another embodiment according to any of the previous embodiments, a component comprises an airfoil.

In another embodiment according to any of the previous embodiments, the entirety of the diffusion section is formed within the coating layer.

In another embodiment according to any of the previous embodiments, a downstream end of the diffusion section extends to a trailing edge, the downstream section is formed entirely in the coating layer.

In another embodiment according to any of the previous embodiments, a downstream end of the diffusion section extends to a trailing edge, with a trailing edge extending straight.

In another featured embodiment, a method of forming cooling holes in a gas turbine engine component includes the steps of forming a cooling hole in a metallic substrate including an inlet extending from an inner face toward an outer extent of the substrate, the inlet merging into a metering section. A coating layer is deposited on the outer extent of the metallic substrate. A diffusion section is formed downstream of the metering section, the diffusion section having a plurality of lobes, and formed at least partially within the coating layer.

In another embodiment according to the previous embodiment, the plurality of lobes includes a first lobe that diverges longitudinally and laterally from the metering section, a second lobe that diverges longitudinally and laterally from the metering section, an upstream end located at the outlet, and a trailing edge defined opposite the upstream end and located at the outlet, and between a first and second sidewall. The first sidewall has a first edge extending along the outlet between the upstream end and the trailing edge, the first edge diverging laterally from the upstream end and converging laterally before reaching the trailing edge, the second sidewall having a second edge extending along the outlet between the upstream end and the trailing edge, and generally opposite the first sidewall. The second edge diverges laterally from the upstream end and converges laterally before reaching the trailing edge.

In another embodiment according to any of the previous embodiments, the formation of cooling hole includes forming the inlet and metering section within the metallic substrate by electro-discharge machining, and utilizing at least one of a water jet and a laser to form at least a portion of the diffusion section in the coating layer.

In another embodiment according to any of the previous embodiments, at least one of a water jet and a laser is utilized to form the cooling hole in both the thermal barrier coating layer, and the metallic substrate.

In another embodiment according to any of the previous embodiments, the coating layer includes a coating layer deposited on a metallic substrate.

In another embodiment according to any of the previous embodiments, the coating layer includes a bonding layer attached to the metallic substrate between the thermal barrier coating and the metallic substrate.

In another embodiment according to any of the previous embodiments, an intermediate coating layer is deposited between the thermal barrier coating and bonding layer.

In another embodiment according to any of the previous embodiments, the component has an airfoil.

In another embodiment according to any of the previous embodiments, the diffusion section is formed within the coating layer.

In another embodiment according to any of the previous embodiments, a downstream end of the diffusion section extends to a trailing edge, and the downstream section is formed entirely in the coating layer.

In another embodiment according to any of the previous embodiments, a downstream end of diffusion section extends to a trailing edge, with a trailing edge extending straight.

These and other features of this application will be best understood from the following specification and drawings, the following of which is a brief description.

### BRIEF DESCRIPTION OF THE DRAWINGS

FIG. 1 schematically shows a gas turbine engine.

FIG. 2A shows a first component that may incorporate the disclosure of the cooling holes according to this application.

FIG. 2B shows a second embodiment.

FIG. 3 is a cross-sectional view through an embodiment of this invention.

FIG. 4 is a top view of a single cooling hole.

FIG. 5A shows a first step in one method of forming the cooling hole.

FIG. 5B shows a second step.

FIG. 6 shows another embodiment.

FIG. 7 shows another embodiment.

### DETAILED DESCRIPTION

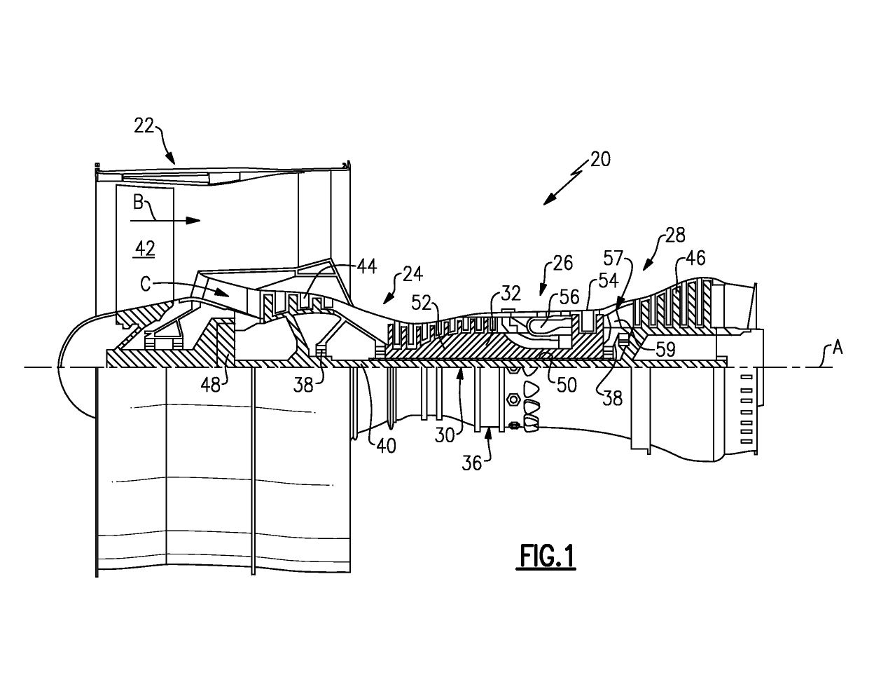

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures, or direct drive or power turbine industrial architecture.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low-pressure compressor 44 and a low-pressure turbine 46. The inner shaft 40 can be connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans or power turbine driven industrial applications.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tambient deg R)/518.7)̂0.5]. The “Low corrected fan tip speed” as disclosed herein according to one non-limiting embodiment is less than about 1150 ft / second.

This application relates to cooling holes in components of the gas turbine engine.

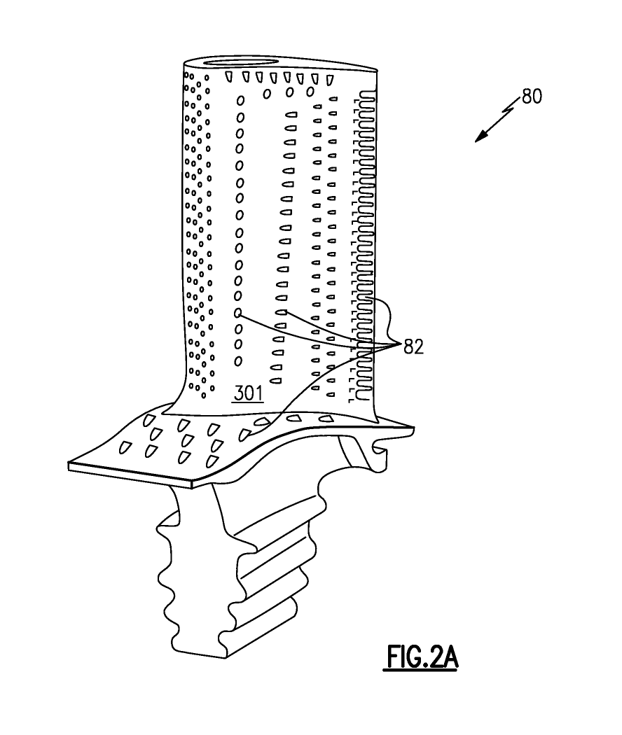

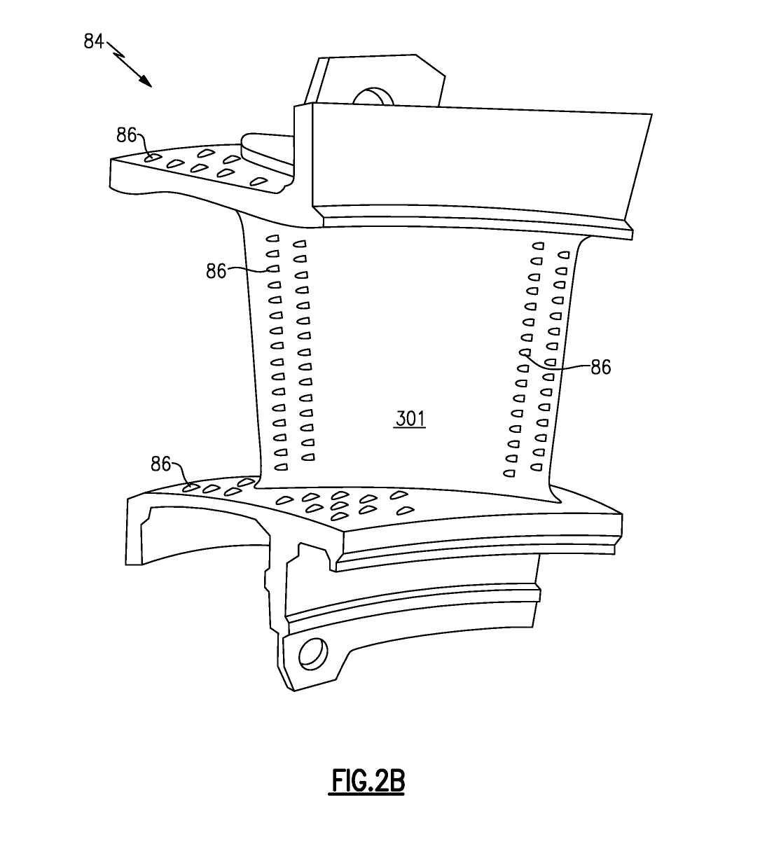

FIG. 2A shows a first embodiment 80, which is illustrated as a turbine blade. As known, a plurality of distinct locations for cooling holes 82 may be formed at an skin 301 of the blade 80.

FIG. 2B shows a second embodiment 84, which is illustrated as a turbine vane. Again, a plurality of cooling holes 86 are formed in the skin 301.

Any of these cooling holes may benefit from the use of a multi-lobed cooling hole formation. The details of a multi-lobed cooling hole will be discussed below. As noted above, such cooling holes have beneficial characteristics.

As shown in FIG. 3, a cooling hole 90 is formed within a metallic substrate 120. The metallic substrate 120, together with a coating layer 122 together form a wall 19 of a component. As known, air flows from cavity 303 into cooling hole 90. Cooling hole 90 may be used as any holes 82 or 86, as examples, or elsewhere on gas turbine components. Metallic substrate 120 extends from an inner face 300, which will be facing into a cavity 303 within a component (e.g., turbine blade 80 or turbine vane 84). The inlet 100 extends to a metering section 101. The metering section extends further outwardly as can be seen, and into an enlarged diffusion section 114. The detail of the sizes of these sections is exemplary, and this application would extend to any number of sizes and orientations of the several distinct sections.

However, FIG. 3 shows a coating layer 122 attached to the metallic substrate 120. The coating layer 122 may include sub-layers, such as a bonding layer 128, an inner coating layer 126, and an outer coating layer 124. Inner coating layer 126 may be selected to bond better to the bonding layer 128, than would be a pure outer layer 124. The outer layer 124 is selected to be a thermal barrier coating as is known in the art, and which will help the component survive the extremely hot temperatures it will face in use. On the other hand, the coating layer 126 may be a thermal barrier coating, or a corrosion resistant coating. Of course, there may be additional layers, such as a third thermal barrier coating outwardly of the outer layer 124. Any number of other combinations of coatings would come within the scope of this application.

FIG. 4 is a top view of the structure shown in FIG. 3 and illustrates one embodiment of cooling hole in greater details. Cooling hole 90 includes inlet 100, metering section 101, diffusion section 114 and outlet 116. Inlet 100 is an opening located on a surface of wall 19, or inner face 300. Cooling air enters cooling hole 90 through inlet 100 and passes through metering section 101 and diffusion section 114 before exiting cooling hole 90 at outlet 116 along an outer skin 301 of wall 19.

Metering section 101 is adjacent to and downstream from inlet 100 and controls (meters) the flow of air through cooling hole 90. In exemplary embodiments, metering section 101 has a substantially constant flow area from inlet 100 to diffusion section 114. Metering section 112 can have circular, oblong (oval or elliptical) racetrack (oval with two parallel sides having straight portions), or crescent shaped axial cross sections. In FIGS. 3 and 4, metering section 101 has a circular cross section. In exemplary embodiments, metering section 101 is inclined with respect to the inner face 300 as illustrated in FIG. 3 (i.e., metering section 101 is not perpendicular to the inner face 300).

Diffusion section 114 is adjacent to and downstream from metering section 101. Cooling air diffuses within diffusion section 114 before exiting cooling hole 90 at outlet 116 along outer skin 301.

A first lobe 600 may diverge longitudinally and laterally from the metering section. A second lobe 601 may also diverge longitudinally and laterally from the metering section. The terms longitudinally and laterally are defined relative to an axis (X) of the metering section 101. An upstream end 604 is located at the outlet 116, and a trailing edge 603 can be defined opposite the upstream end 604 and located at the outlet 116, and between a first 605 and second 607 sidewall. The first sidewall has a first edge 609 extending along the outlet between the upstream end 604 and the trailing edge 603. The first edge 609 diverges laterally from the upstream end 604 and converges laterally before reaching the trailing edge 603. The second sidewall 607 has a second edge 611 extending along the outlet 116 between the upstream end 604 and the trailing edge 603, generally opposite the first sidewall. The second edge 611 diverges laterally from the upstream end 604 and converges laterally before reaching the trailing edge 603.

A downstream portion 108 can be seen in FIGS. 3 and 4 as extending from a point 109 which extends at a lesser angle relative to outer skin 301, compared to the angle of the more upstream portions of the diffusion section 114. This area 108 extends to the trailing edge 603. As can be appreciated in FIG. 4, the trailing edge 603 is generally straight, and defines the extreme-most downstream end across the entire width of the hole. Stated another way, for a symmetrical embodiment as shown in FIG. 4, the trailing edge 603 defines an angle A with an extension of an axis parallel to the centerline X, and the angle A is a square angle. Of course, holes with a non-square trailing edge would also benefit from these teachings.

Notably, the multi-lobes can look quite different from FIG. 4 as long as the basic description of a multi-lobed cooling hole as included above is achieved. For example, the multi-lobe cooling hole encompasses different combinations of the various features that are shown, including metering sections with a variety of shapes, and diffusion sections with one, two or three or even more lobes, in combination with different downstream portion 108 bordered by various trailing edge 603. The multi-lobes can be asymmetrical.

In the prior art, multi-lobed cooling holes formed by electro-discharge machining require a conductive base be machined. The coating layer 122 is non-conductive. Thus, some novel means of forming the multi-lobed structure in the coating layer 122 is required.

Returning for a moment to FIG. 3, one can see that portions of the multi-lobed structure are formed within the coating layers that together form layer 122. Notably, layer 122 can include additional layers, or fewer layers. What is generally required is that there be an outer thermal barrier coating 124 in the coating layer 122 which is deposited on an outer extent 121 of metallic substrate 120.

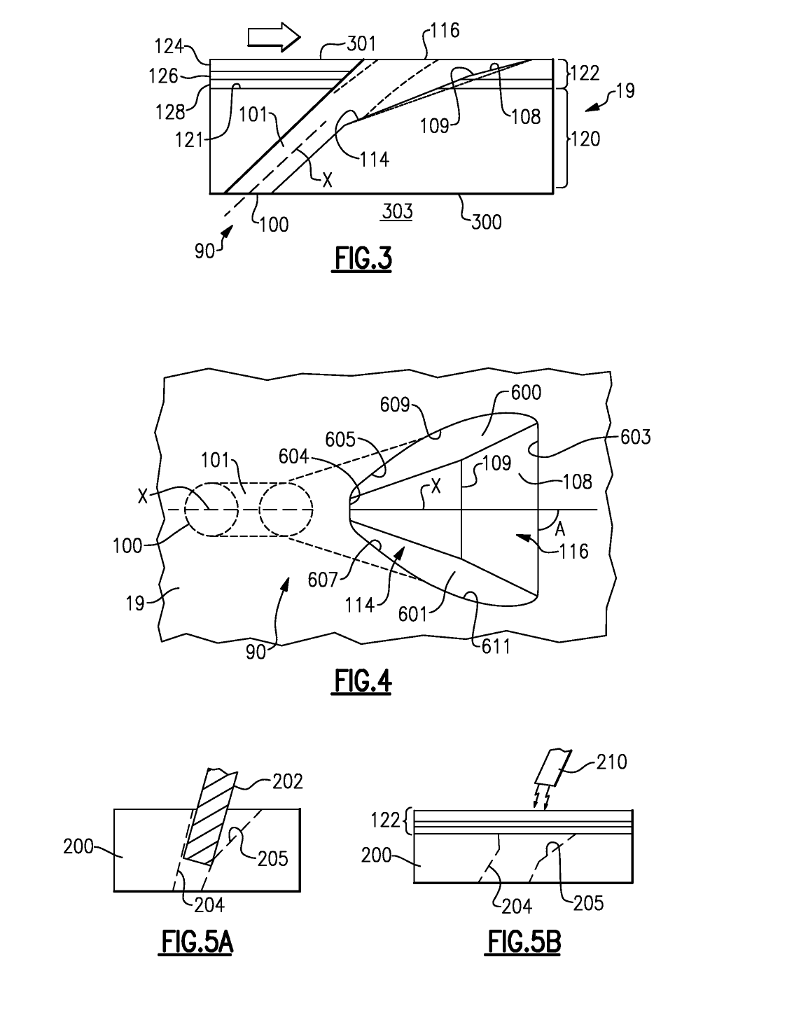

FIG. 5A shows one way of forming the final hole. In FIG. 5A, an electro-discharge machining tool 202 is forming a hole 204 in a substrate 200. Hole 204 will be a metering section. Also, a portion 205 of a diffusion section is formed. Once this hole combination 204/205 is formed, the coating layer 122 may be deposited. As shown in FIG. 5B, the coating layer may be extended over the hole combination 204/205. In practice, it may not entirely cover the hole as illustrated in FIG. 5B. A mask may be used to cover the hole combination 204/205. However, portions of this coating must be removed. Thus, a removal technique that is effective for non-conductive surfaces is utilized. As shown in FIG. 5B, a tool 210 is utilized. The tool 210 may be water jet, or may be a laser. After application of the tool 210 to remove material from the hole combination 204/205, the hole will resemble that which is shown in FIG. 4, and have the multi-lobes. Notably, orders of the steps can be changed.

The tool may also be utilized to form the hole in the metallic substrate, as an alternative method.

Another wall embodiment 900 is shown in FIG. 6. In embodiment 900, the inlet 901 of the cooling hole 690 extends into a metering section 910, and then to the diffusion section 614. The diffusion section 614 extends to the outlet 616 at outer skin 902. As also shown, there is a section 608 extending from a point 909 (equivalent to 109 shown in FIGS. 3 and 4) that extends to the trailing edge, as in the embodiments shown in FIGS. 3 and 4. In embodiment 900, the coating layers 622 incorporate layers 624, 626, and 628. The entire diffusion section 614 is formed within the coating layers. The metering section 910 is formed entirely within the metallic substrate 620.

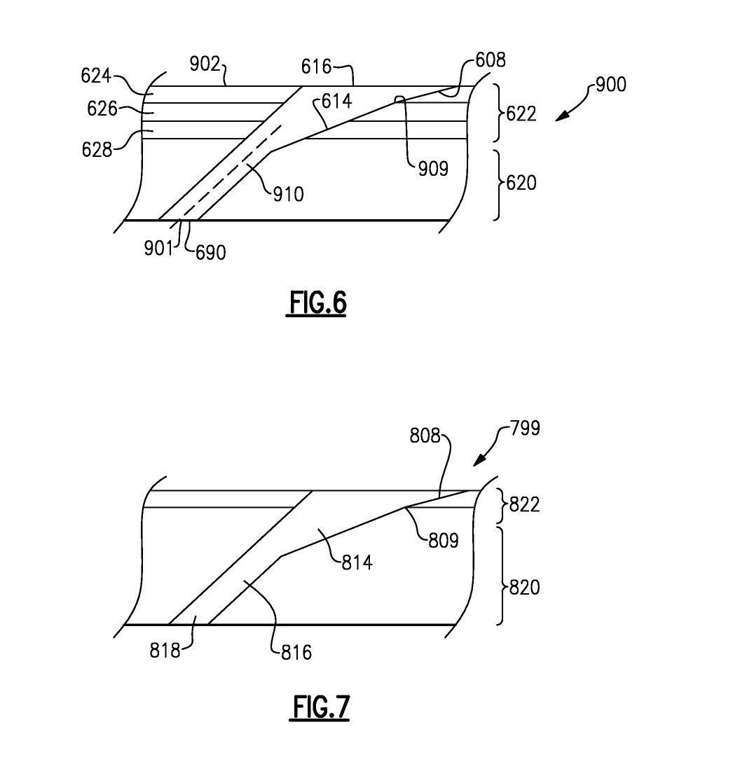

Another wall embodiment 900 is shown in FIG. 7. The entirety of the more downstream portion 808 is formed within the coating layers 822. In the embodiment, the portions 816/814 of the cooling hole 818 within metallic substrate 820 can be electro-discharge machined or other manufacturing technologies known in the art can be used. The downstream portion 808, downstream of point 809 (equivalent to 109 shown in FIGS. 3 and 4), formed within the coating layer 822, can be made using tools such as a water jet or a laser or combination thereof.

While the disclosed embodiments all show the skin at an outer surface of the component, it is also possible the wall could be an interior wall, and thus the skin would not be at an outer surface of the component.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine component comprising:
a wall having an inner face, and a skin;
a plurality of cooling holes extending from said inner face to said skin, said cooling holes including an inlet extending from said inner face and merging into a metering section, and a diffusion section downstream of said metering section, and extending to an outlet at said skin;
said diffusion section including a plurality of lobes, and a coating layer at said skin, with at least a portion of said plurality of lobes formed within said coating layer; and
a downstream end of said diffusion section extending to a straight trailing edge, and said downstream section being formed at least partially in said coating layer.

2. The gas turbine engine component as set forth in claim 1, wherein said plurality of lobes includes a first lobe that diverges longitudinally and laterally from the metering section, a second lobe that diverges longitudinally and laterally from the metering section, an upstream end located at the outlet, and the trailing edge defined opposite the upstream end and located at the outlet, and between a first and second sidewall, the first sidewall having a first edge extending along the outlet between the upstream end and the trailing edge, the first edge diverging laterally from the upstream end and converging laterally before reaching the trailing edge, the second sidewall having a second edge extending along the outlet between the upstream end and the trailing edge, and generally opposite the first sidewall, the second edge diverging laterally from the upstream end and converging laterally before reaching the trailing edge.

3. The gas turbine engine component as set forth in claim 1, wherein said coating layer comprising a thermal barrier coating.

4. The gas turbine engine component as set forth in claim 3, wherein said coating layer includes a bonding layer attached to the metallic substrate, and which is between said thermal barrier coating and said metallic substrate.

5. The gas turbine engine component as set forth in claim 4, wherein there is an intermediate coating layer between said thermal barrier coating and said bonding layer.

6. The gas turbine engine component as set forth in claim 4, wherein said component comprises an airfoil.

7. The gas turbine engine component as set forth in claim 1, wherein the entirety of said diffusion section is formed within said coating layer.

8. The gas turbine engine component as set forth in claim 1, wherein said downstream section is formed entirely in said coating layer.

9. (canceled)

10. A method of forming cooling holes in a gas turbine engine component comprising the steps of:
a) forming a cooling hole in a metallic substrate including an inlet extending from an inner face toward an outer extent of the substrate, said inlet merging into a metering section;
b) depositing a coating layer on the outer extent of the metallic substrate;
c) forming a diffusion section downstream of said metering section, said diffusion section having a plurality of lobes, and formed at least partially within said coating layer;
d) including a coating layer deposited on a metallic substrate; and
e) extending a downstream end of said diffusion section to a straight trailing edge, and forming said downstream end at least partially in said coating layer.

11. The method as set forth in claim 10, wherein said plurality of lobes includes a first lobe that diverges longitudinally and laterally from the metering section, a second lobe that diverges longitudinally and laterally from the metering section, an upstream end located at the outlet, and the trailing edge defined opposite the upstream end and located at the outlet, and between a first and second sidewall, the first sidewall having a first edge extending along the outlet between the upstream end and the trailing edge, the first edge diverging laterally from the upstream end and converging laterally before reaching the trailing edge, the second sidewall having a second edge extending along the outlet between the upstream end and the trailing edge, and generally opposite the first sidewall, the second edge diverging laterally from the upstream end and converging laterally before reaching the trailing edge.

12. The method as set forth in claim 10, wherein the formation of said cooling hole includes forming said inlet and said metering section within said metallic substrate by electro-discharge machining, and utilizing at least one of a water jet and a laser to form at least a portion of said diffusion section in said coating layer.

13. The method as set forth in claim 10, wherein at least one of a water jet and a laser is utilized to form said cooling hole in both said thermal barrier coating layer, and said metallic substrate.

14. (canceled)

15. The method as set forth in claim 10, wherein said coating layer includes a bonding layer attached to the metallic substrate, and which is between said thermal barrier coating and said metallic substrate.

16. The method as set forth in claim 15, wherein an intermediate coating layer is deposited between said thermal barrier coating and said bonding layer.

17. The method as set forth in claim 10, wherein said component has an airfoil.

18. The method as set forth in claim 10, wherein the entirety of said diffusion section is formed within said coating layer.

19. The method as set forth in claim 14, wherein said downstream section is formed entirely in said coating layer.

20. (canceled)
